(19) United States
(12) Patent Application Publication
(10) Pub. No.: US 2012/0229475 A1
(43) Pub. Date: Sep. 13, 2012

(54) Animation of Characters

(75) Inventors: Barry Sheridan, Glasgow (GB); David Niall Cumming, Glasgow (GB)

(73) Assignee: DIGIMANIA LIMITED, Glasgow (GB)

(21) Appl. No.: 13/392,613

(22) PCT Filed: Aug. 6, 2010
(86) PCT No.: PCT/GB2010/051305

§ 371 Date: May 8, 2012

(30) Foreign Application Priority Data
Aug. 28, 2009 (GB) 0915016.0

(51) Int. Cl. G06T 13/00

(52) U.S. Cl. 345/474

(57) ABSTRACT

An animation method in which a user directs the actions of characters on a virtual stage, rather than instructing every individual movement. Such a method of producing an animated video comprises providing a virtual stage; providing templates from which characters can be assembled, each character having a body and limbs, and the templates providing facial features and clothes with differing colours and shapes; providing objects that can be placed on the virtual stage; placing the objects and the characters on the virtual stage; instructing each character as to his emotional state, and as to any required movement; wherein each character continuously and automatically behaves in accordance with the specified emotional state. Instructions to a character about a desired body movement, such as stepping in one direction or another, or turning on the spot, or walking or running along a specific route, may be provided by a sectored base ring, the sectors displaying arrows that correspond to different steps; while dragging the base ring or a marker along a route across the virtual stage causes the character to follow that route, walking or running depending on how fast the marker had been moved.

The present invention relates to a method and apparatus whereby an animated video can be created, in which characters can be manipulated to move, and in which characters can move their lips in synchronisation with an audio track.

In this specification the term video is used to mean a recorded sequence of moving images, whatever the storage medium; and it therefore encompasses moving images recorded on film or recorded electronically. Typically the moving images are associated with a sound track.

Traditionally, animations of three-dimensional characters are created by moving each limb separately, to achieve the desired sequence of movements. This can be a time-consuming procedure.

In one aspect the present invention provides a web site to enable and enhance collaboration between people working on an animation, for example script writers, speakers, animators, and voice-overs.

In another aspect the present invention enables the user to direct the actions of characters on a stage, rather than instructing every individual movement.

According to the present invention there is provided a method of producing an animated video comprising:

providing a virtual stage;

providing templates from which characters can be assembled, each character having a body and limbs, and the templates providing facial features and clothes with differing colours and shapes;

providing objects that can be placed on the virtual stage

placing the objects and the characters on the virtual stage;

instructing each character as to his emotional state, and as to any required movement;

wherein each character continuously and automatically behaves in accordance with the specified emotional state.

Preferably the method involves repeatedly rehearsing at least a portion of the animated video, and on each rehearsal the user may make changes and provide specific instructions, and on each following rehearsal those changes and instructions are automatically followed. For example the method may involve instructing a character to perform a specific action at a particular time, the character then repeating the specified action at that time during the rehearsals that follow.

The animation may be associated with an audio track, and during rehearsal the characters may be instructed to synchronise lip movements with the audio track; and may be instructed to change facial expressions or nod their head or move their eyes at particular times during rehearsal.

Preferably the virtual stage is provided with a plurality of alternative light sources, and is provided with a plurality of different cameras, so that the characters can be illuminated from specified positions, and can be viewed from different camera positions. The user can also select what lighting to provide. During rehearsals the user can cut between different cameras. When the rehearsals have been completed satisfactorily, the user can record the final video.

Preferably, in order to provide instructions to a character about a desired body movement, such as stepping sideways, or turning on the spot, or walking or running along a specific route, each character is provided with an associated sectored base ring, different sectors displaying arrows that correspond to different stepping movements. Selecting a particular sector causes the character to perform the corresponding steps. And dragging the base ring along a route across the virtual stage causes the character to move along that route, the character walking or running depending on how fast he has to go.

The invention also provides software to enable this method to be performed; and provides a computer system programmed with such software.

The invention will now be further and more particularly described, by way of example only, and with reference to the accompanying drawings in which:

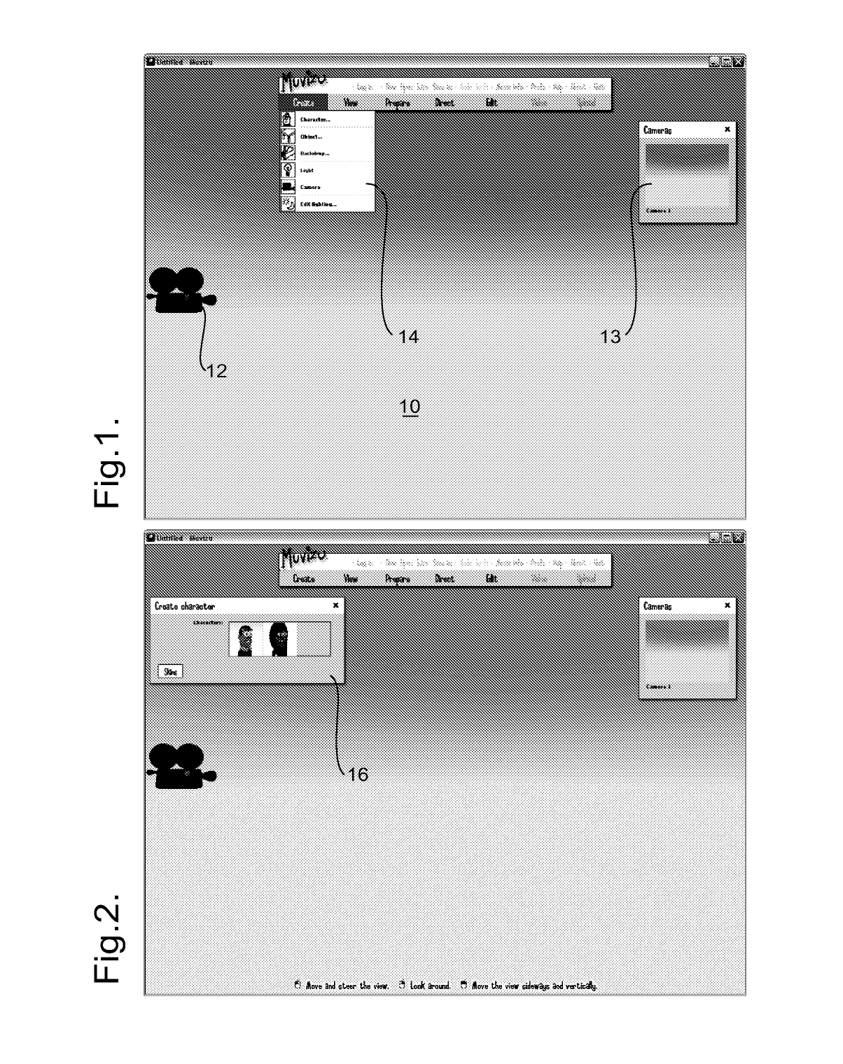

FIG. 1 shows an initial screen view, and the create menu;

FIG. 2 shows a control box for creating characters;

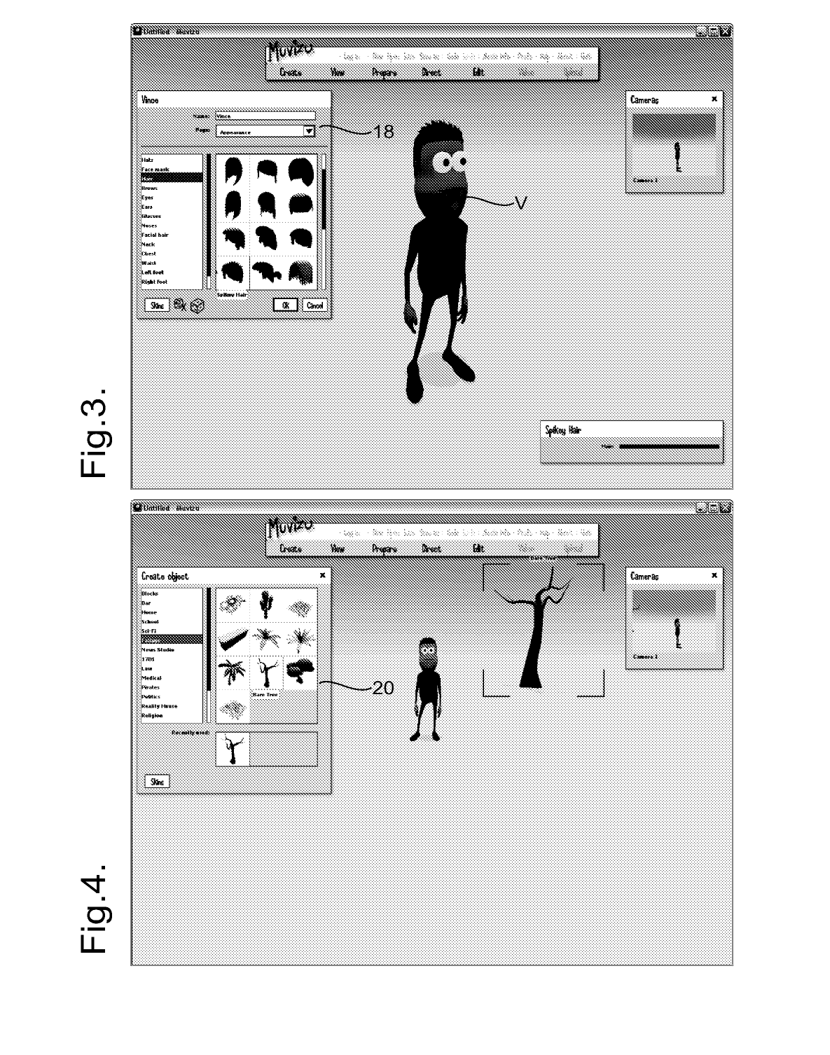

FIG. 3 shows a control box for modifying appearance of a character;

FIG. 4 shows a control box for creating objects;

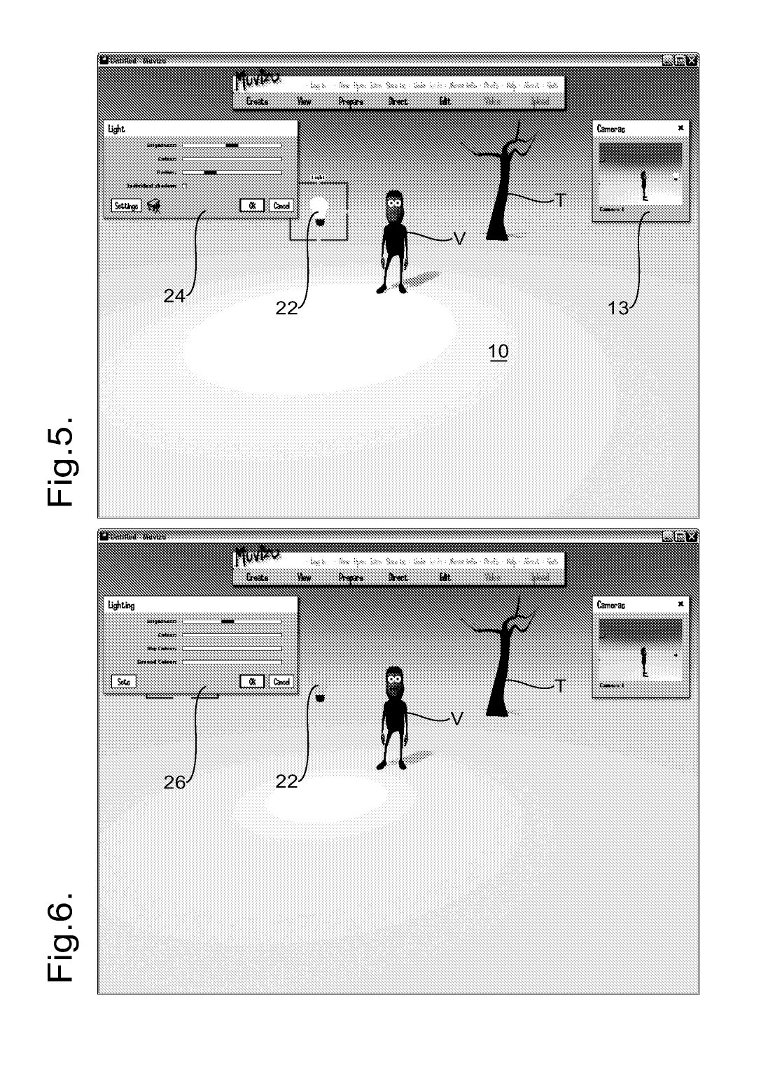

FIG. 5 shows a control box for editing light settings;

FIG. 6 shows a control box for editing scene lighting;

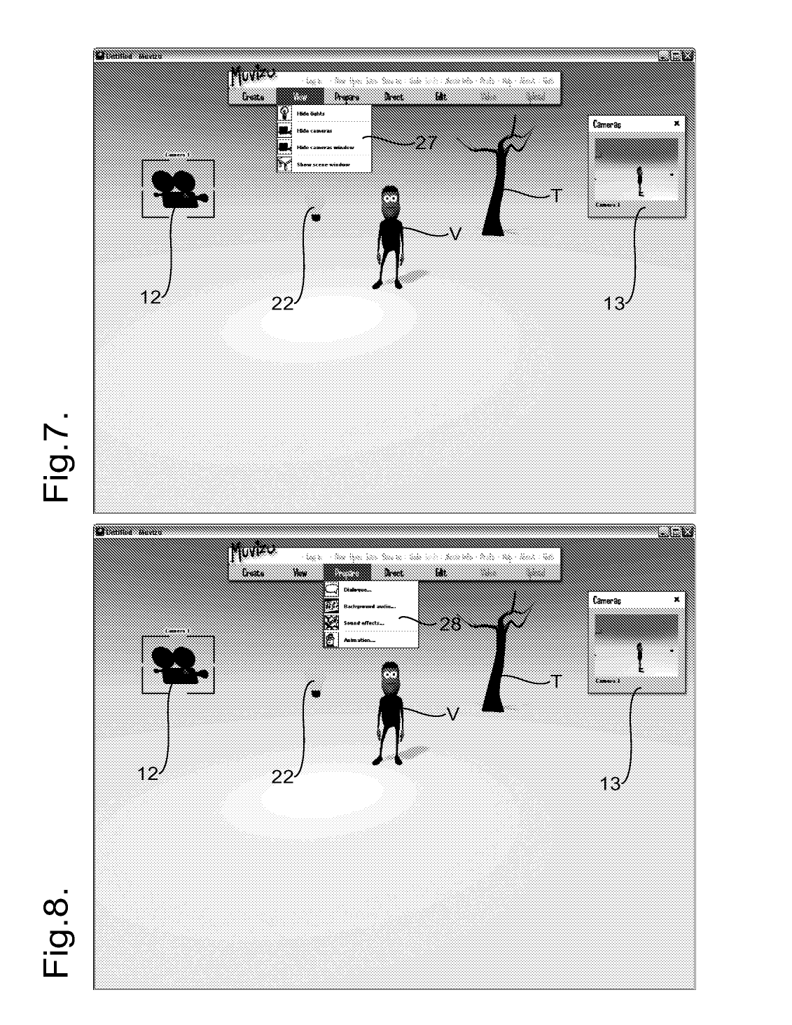

FIG. 7 shows the view menu;

FIG. 8 shows the prepare menu;

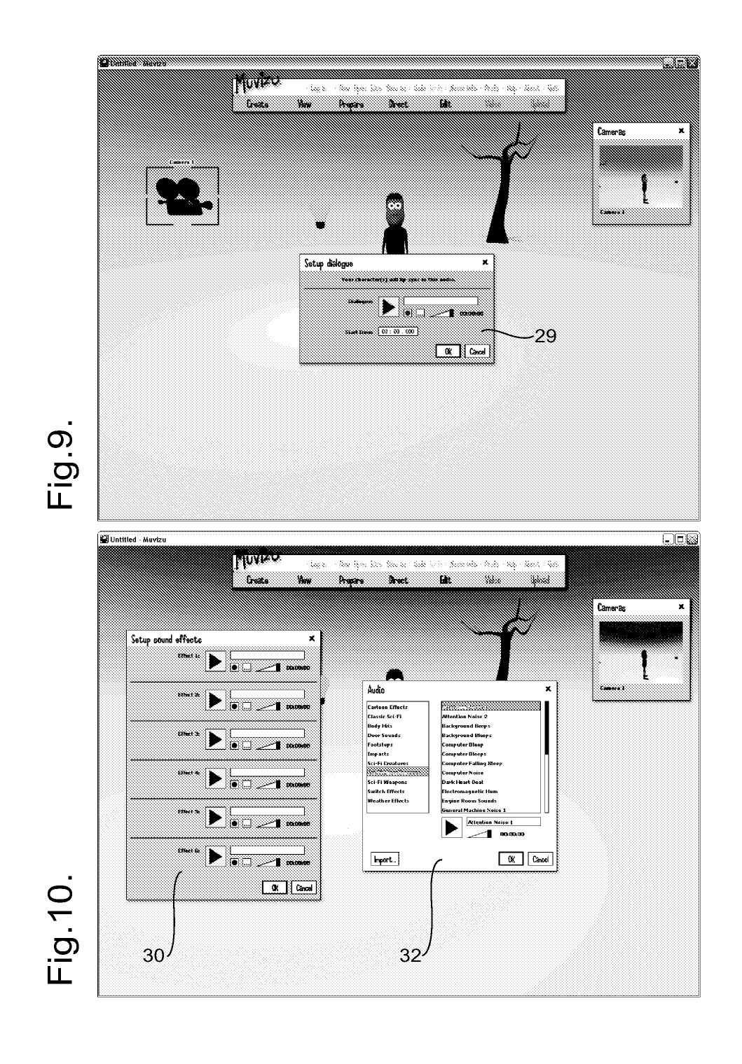

FIG. 9 shows a control box for setting up dialogue;

FIG. 10 shows a control box for setting up sound effects;

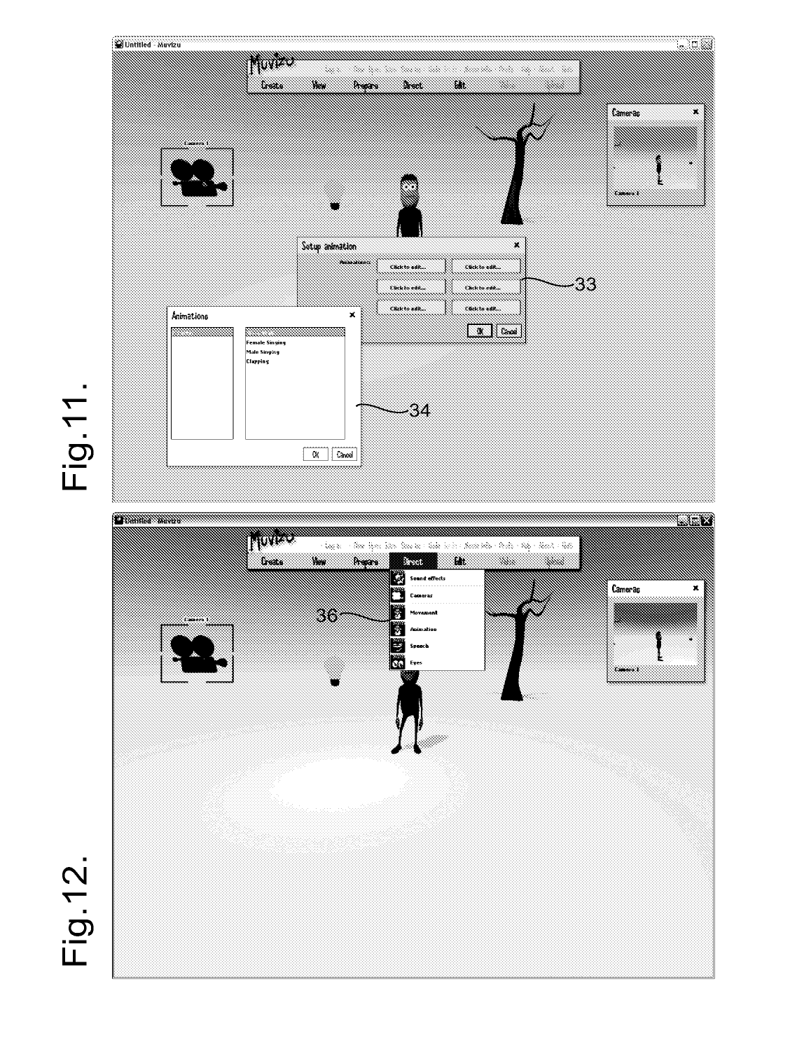

FIG. 11 shows a control box for setting up animations;

FIG. 12 shows the direct menu;

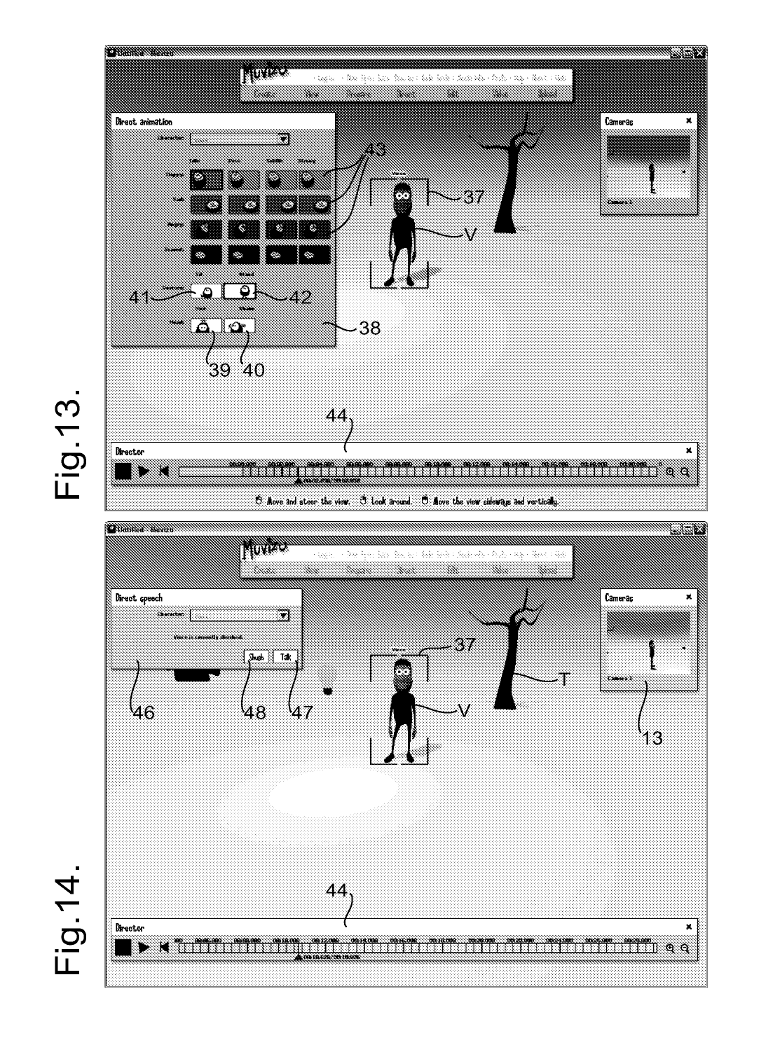

FIG. 13 shows a control box for directing character animation;

FIG. 14 shows a control box for directing character speech;

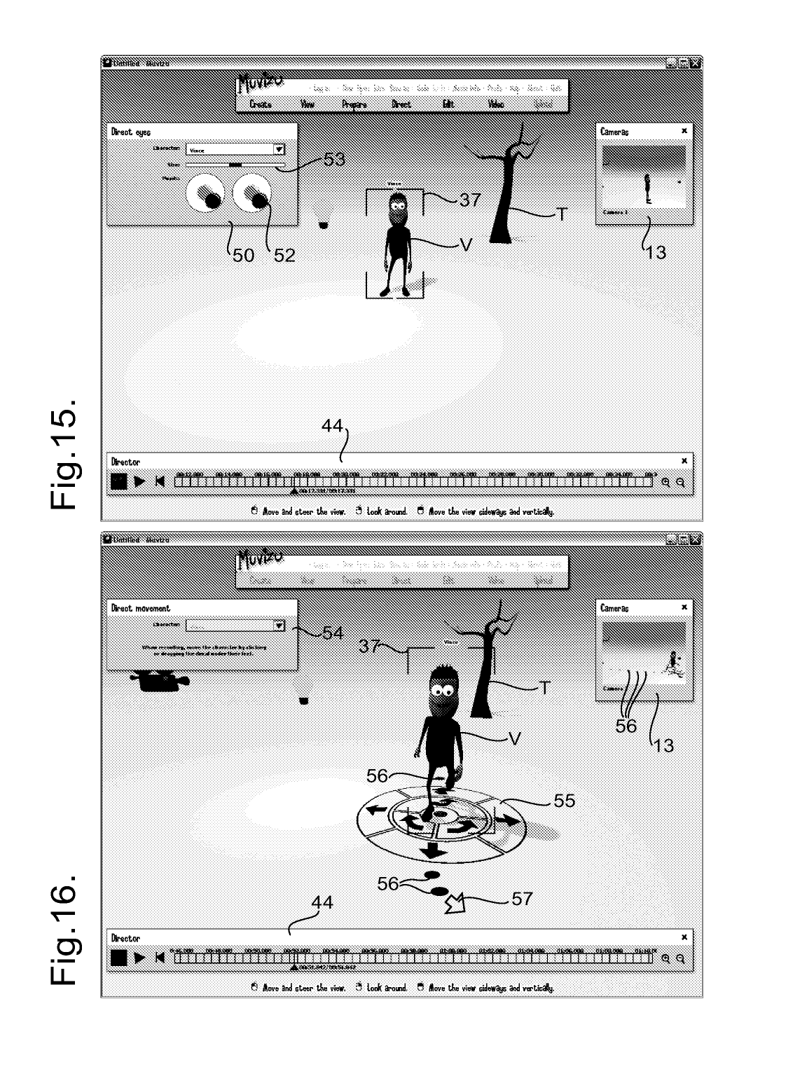

FIG. 15 shows a control box for directing character eye movements;

FIG. 16 shows a control box for directing character movement;

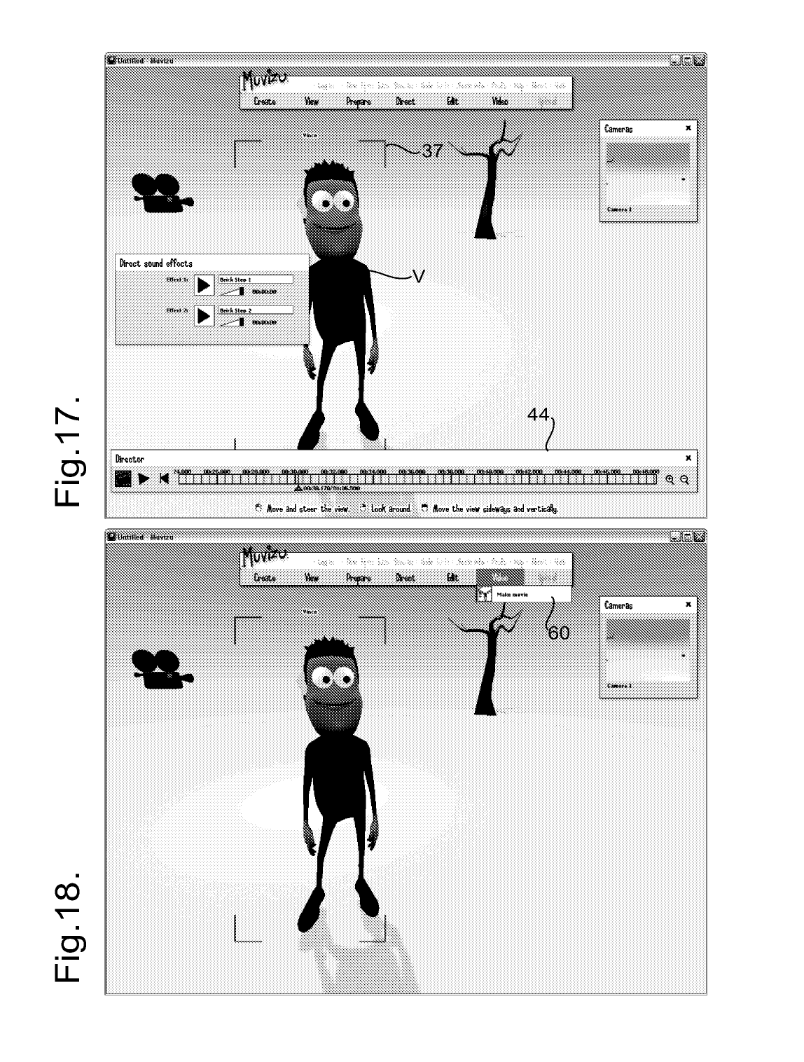

FIG. 17 shows a control box for directing sound effects;

FIG. 18 shows the video menu;

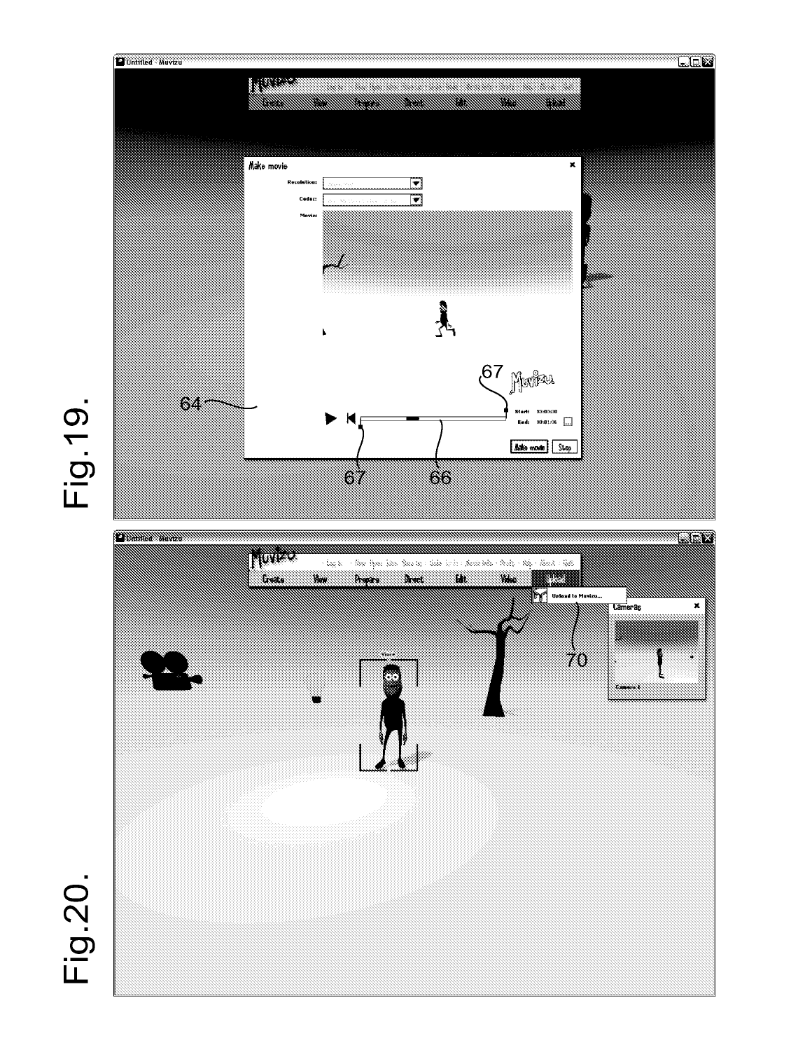

FIG. 19 shows a control box for making a video; and

FIG. 20 shows the upload menu.

The present invention provides the ability for a user to create an animated video in which there are one or more characters and one or more props. The user makes use of a suitably-programmed computer, or dedicated equipment; typically the computer would incorporate a processing unit and memory (including read only memory and random access memory), a hard disk drive, a display screen, a keyboard, and a pointing device or mouse. These components are conventional. The pointing device might be a track pad, a track ball, or other devices suitable for moving a cursor on the display screen. In the following description it is assumed that the user can control the computer with a mouse.

Referring to FIG. 1, the procedure is analogous to that of shooting a film, and the initial screen view corresponds to a silent stage 10. A first stage of operation involves creating characters and objects on this stage 10. There is always at least one camera 12 that views the stage 10, and a camera view window 13 that displays the view as seen by the camera 12. The Create menu 14 provides the options of creating characters, objects, backdrops, light sources, cameras, and of editing the lighting. The position of the camera 12 can be moved around the stage 10, typically by using a computer mouse (not shown). Furthermore, as indicated at the bottom of the screen, the viewpoint of the user relative to the stage 10 can be changed in a similar way: clicking on the left mouse button to move around the stage, clicking on the right mouse button to rotate, and clicking on both right and left mouse buttons simultaneously to move the viewpoint up-and-down or side-to-side.

FIG. 2 shows the screen view if the user selects the create character option. The user can select either a male or female character from a control box 16. As shown in FIG. 3, a corresponding character V then appears on the stage 10, and by means of a control box 18 the user can give the character V a name, and can select aspects of the character's appearance by choosing from several different features: for example hats, hair, eyebrows, eyes, ears, glasses, nose, etc.. Each of these features can also be given a desired colour.

FIG. 4 shows the screen view when the user has selected the create object option. The user can select from a wide range of different types of object in a control box 20; in this case the user has selected from the category “foliage”, and within that category has selected “bare tree”. In a similar way items of furniture, bookcases, tables, chests, lamps, telescopes, etc can be selected. Such items can be placed on the stage, and arranged in a desired orientation. For example the object may be moved around on the stage using a left click of the mouse; it may be rotated about a vertical axis using a right click of the mouse; it may be moved vertically using both left and right clicks; and it may be scaled to a desired size using a left click combined with rotation of the mouse wheel. Such objects, as the default setting, stand on the stage 10, but their properties may be modified, for example the object may have the property of always remaining upright; or of being unaffected by gravity (so it can be placed up against a wall, as if suspended there); or the property that it can be stood on. Similarly the colours of the object may be modified.

Referring back to FIG. 1, a further option would be to select a backdrop. Such a backdrop is curved or flat, and generally of rectangular shape, and its surface may be covered with an image. This might for example represent a wall. Yet another option is to create additional cameras so that the scene can be viewed simultaneously from different directions (subsequently the user will be able to cut between the views of different cameras). During this initial procedure, the position, orientation, and field of view of the or each camera 12 can be set up by the user.

Referring to FIG. 5, the stage 10 may be illuminated by ambient light, or by discrete light sources, and in each case the colour and brightness of the light can be selected and adjusted. In FIG. 5 the character V and the tree T are on the stage, and a discrete light source 22 is being introduced. The control box 24 enables the brightness and colour of the light to be selected, and the radius that is to say the distance that the light propagates from the light source 22. FIG. 6 shows the control box 26 for controlling the scene lighting, that is to say the ambient lighting, in a similar fashion.

The items on the virtual stage 10—characters, objects or backdrops—are shown as being three-dimensional, so that they are shown in perspective, and they cast shadows from the light sources 22 both on the on the virtual stage 10 itself and on the characters or objects themselves. Indeed all the items are viewable in this three-dimensional fashion from any camera position, or by the user (in his role as the director) from any viewpoint. If the user, by means of the mouse, moves the viewpoint (in the way mentioned in relation to FIG. 1) to beside or behind an object, then the user will see the side or the rear of the object; for example if the prop is a car, the car may be viewed from any direction. During the filming process, the cameras 12 and light sources 22 are not visible in the video image. However it may be convenient, during set up, to hide one or other of these features. This facility is provided by the View menu 27, shown in FIG. 7.

Having created the requisite characters and objects on stage, the next step is to prepare the requisite audio streams. Referring to FIG. 8, the Prepare menu 28 enables the user to collate the requisite sounds and to prepare any required animations. Referring to FIG. 9, the dialogue control box 29 enables the user to import a sound stream of speech (monologue or dialogue). Referring to FIG. 10, the sound effects control box 30 enables six different sound effects to be prepared, each of which can be selected from many different pre-recorded sound effects as shown in control box 32, or alternatively a desired sound effect can be imported.

Referring to FIG. 11, a number of prepared animations may be preselected, as indicated in the set up animations control box 33, and the selection box 34. By way of example these might include singing to a microphone, or clapping, or waving, or performing dance steps.

The next step is to direct a rehearsal of the video. During each such rehearsal the character or characters V can be directed to perform certain actions, and during subsequent rehearsals each character V will continue to perform those actions in addition to any further actions that they are directed to perform. Hence the video can be gradually prepared in successive rehearsals, introducing one or more actions each time. A significant aspect of the present invention is that each character V is not static, even when standing still, as the arms will move slightly as if the character V is breathing, and the head may also move slightly, or the eyes may blink. These actions take place automatically, without any instruction from the user. Referring to FIG. 12 the Direct menu box 36 provides various options: sound effects, cameras, movement, animations, speech and eyes. As shown in each of FIGS. 13-17, during each rehearsal a timeline 44 representing the rehearsal is shown along the bottom of the screen, so that a particular action may be introduced at a particular time, and if necessary the user can move forward or backwards to a particular time during the rehearsal. If necessary the user may rehearse just a short part of the animated sequence.

Referring to FIG. 13, each character V must be given a mood, the default setting being “happy/idle”; this mood may be altered during the course of a rehearsal. When a character V has been selected by the user, the character is highlighted by a broken rectangular frame 37. The direct animation control box 38, which comes up when the user selects the animation option in the Direct menu 36 of FIG. 12, provides the facility for instructing the selected character V to nod or shake his head (boxes 39 and 40), or to sit or to stand (boxes 41 and 42). The mood or emotional state in this example must be selected from happy, sad, angry or scared; and each of these moods is provided with four levels of intensity, ranging from only slightly happy to being very happy, etc, these levels of intensity being referred to here as idle, pose, subtle and strong. Thus the character V must at all times have one of these 16 different moods, selected from the boxes 43. The character behaves in accordance with the specified mood, whatever he is doing, when standing still, walking or running: in each case the character acts in accordance with the specified mood. For example if the mood is strongly angry, then the facial expression would express this mood, and the character would perform randomly-selected hand gestures that correspond to this mood; and if walking, he would walk in an angry way. It will be appreciated that the system may be modified to provide additional moods or emotional states that may be selected, for example inebriated.

Referring to FIG. 14, a selected character V may be arranged to speak, that is to say his lips may be synchronised to speech in an audio stream (previously imported as explained in relation to FIG. 9), by selecting the speech option in the Direct menu 36 shown in FIG. 12. If there are two characters on the stage 10, and the audio stream is of two people talking, then one character would have his lips synchronised to one of the voices, and then the other character would have his lips synchronised to the other voice. If the selected character V is to speak in this way, then in the control box 46 the talk box 47 would be clicked, whereas when the selected character V is not to talk (because the other voice is speaking), then the shush box 48 would be clicked.

Referring to FIG. 15, a selected character V may be arranged to move his eyes from side to side or up-and-down, by selecting the eyes option in the Direct menu 36 of FIG. 12. This provides an eye movement control box 50, and the user can then move one or other of the pupils 52 shown in the control box 50 using the mouse. Both the pupils of the selected character V move in exactly the same way, at the same time. The control box 50 also allows the eyes to be changed in size with a slider 53.

Referring to FIG. 16, a selected character V may be arranged to move around the stage 10, by selecting the movement option in the Direct menu 36 of FIG. 12. The selected character V in this case is then shown as standing on a roundel 55. The roundel 55 has an inner ring with arrows which when clicked on cause the character V to turn 45° to the right, to turn 45° to the left, or to turn right round, respectively. The roundel 55 then has an outer ring with four radially-directed arrows, which when clicked on cause the character V to take a step to the left, or a step backwards, or a step to the right, or a step forwards, respectively. Hence by clicking on appropriate sectors of the roundel 55 the character V is directed to turn or make single steps. If the cursor (associated with the computer mouse) is moved as if to drag the roundel 55 along a desired path, then the character V will walk along the path, following the cursor which is then displayed as an arrow 57. Under these circumstances the roundel 55 would vanish from the display. If the arrow 57 is moved slowly, then the character V walks, whereas if the arrow 57 is moved faster, then the character V will run. The speeds of walking and of running are in this example preset, in accordance with the mood of the character; for example a sad walk is slower than a happy walk. The path followed by the arrow 57 is shown by a line of dots 56 across the stage 10, which are also visible in the camera view window 13. (These dots 56 are not visible in the final video.) This line of dots 56 hence shows the path along which the character is to move, or has moved; and the spacing of the dots indicates whether the movement is walking or running.

Referring to FIG. 17, sound effects may be introduced by selecting the sound effects option in the Direct menu 36 of FIG. 12. For example the user may introduce such sounds in synchronisation with the character's footsteps.

These various directing steps can be carried out in successive rehearsals, and they are cumulative. For example the character V might be arranged, in a first rehearsal, to walk to behind the tree T; to stand there; and then to run towards the camera. In the next rehearsal the character V might be arranged to be in the happy, idle mood during the walk; and to be in the slightly scared mood after coming from behind the tree. The mood or emotional state affects not only the facial expression, but also the style and body movement involved in walking and running. In the next rehearsal the character V might be arranged, when behind the tree, to move his eyes to look in both directions, left and right, before running. And in the next rehearsal the character V might be arranged to speak, that is to move his lips in synchronisation with spoken words from a previously-prepared audio file, during the walk towards the tree; and to shout “help!” when running.

When the user is satisfied with all the aspects of the animated sequence, the user can then move to the stage of making and storing a video. Referring to FIG. 18, the Video menu box 60 offers just one option: that of making a movie or video. If this is selected, as shown in FIG. 19, a control box 64 enables the user to produce a video with a specified resolution and a specified codec, each of which is selected from corresponding drop-down lists. Along the bottom of the control box 64 is a timeline 66 corresponding to the complete rehearsal, with markers 67 indicating the beginning and end of the portion of the rehearsal that is to be converted into the video. In this case the entire rehearsal timeline is to be converted. This then generates a video datastream which is stored on the user's computer.

Finally, if the user wishes to share this video with other people, as illustrated in FIG. 20 the Upload menu box 70 provides an option: that of uploading the saved video to a web site.

It will thus be appreciated that the method of the present invention enables the user to direct the characters—to instruct them as to their emotional state, and to direct them as to where to go on the stage—without having to provide detailed instructions as to how to move their limbs, for example. Each character has a body, with legs, arms and a head. The present method uses commercially available software used for programming video games, which enables the body parts to move in realistic ways; a suitable software is that known as Unreal Engine™, available from Epic Games Inc. The present invention provides, for each of the different emotional states or moods that may be selected—such as happy/idle or sad/pose—several different actions appropriate to standing still, and several different actions appropriate to walking or to running; and these different actions are automatically and randomly selected. So even when the user is not explicitly providing instructions to a character on the stage 10, that character will continuously behave in a realistic fashion. Typically the actions are more prominent the stronger the emotional intensity, so that for example in the idle state there may be no hand gestures, in the pose state there may be occasional small hand gestures and slight changes of leg position, in the subtle state there may be larger hand gestures, while in the strong state there would be several different and vigorous hand gestures indicative of the emotional state.

Although the actions are selected automatically and randomly on the first rehearsal in which a character appears, unless otherwise instructed by the user the character will repeat the same actions in subsequent rehearsals.

Similarly, the user directs the character where to move and how fast to move on the stage 10, but does not have to instruct the requisite leg movements.

Although the operation of the method described above has mentioned tasks performed by a user, it will be appreciated that more than one user may be involved in the production process for example a script writer, one or more speakers, and animators.

What is claimed:

1. (canceled)

2. A method whereby a user may produce an animated video using a computer, comprising:
the computer providing a virtual stage;
the computer providing templates from which characters can be assembled, each character having a body and limbs, and the templates providing facial features and clothes with differing colours and shapes;
the computer providing objects that can be placed on the virtual stage;
a user placing the objects and the characters on the virtual stage; and
the user controlling the actions of the characters in at least one rehearsal, and then the user generating a video datastream of the last rehearsal;
wherein
the user directs each character as to his emotional state, and as to any required movement;
the computer provides, for each different emotional state that may be selected, a plurality of different actions appropriate to a character that is standing still, a plurality of different actions appropriate to a walking character, and a plurality of different actions appropriate to a running character;
and wherein the computer ensures that each character continuously and automatically behaves in accordance with the specified emotional state by automatically and randomly selecting actions that ^{correspond} to the selected emotional state and to the required movement.

3. A method as claimed in claim 2 comprising repeatedly rehearsing at least a portion of the animated video, wherein on each rehearsal the user may make changes and provide specific directions, and on each following rehearsal those changes and directions are automatically followed.

4. A method as claimed in claim 2 wherein, during a rehearsal the animation is associated with an audio track, and the characters are instructed to synchronise lip movements with the audio track.

5. A method as claimed in claim 2 wherein, during a rehearsal, the user instructs each character to change facial expressions or to nod their head or move their eyes at particular times during rehearsal.

6. A method as claimed in claim 2 wherein the virtual stage is provided with a plurality of alternative light sources.

7. A method as claimed in any claim 2 wherein the virtual stage is provided with a plurality of different cameras.

8. A method as claimed in claim 2 wherein, in order to provide instructions to the character about a desired body movement, the character is provided with a sectored base ring, different sectors displaying arrows that correspond to different steps; the method comprising the user selecting a particular sector and the character performing the corresponding steps.

9. A method of producing an animated video of a character, wherein, in order to provide instructions to the character about a desired body movement, the character is provided with a sectored base ring, different sectors displaying arrows that correspond to different steps; the method comprising the user selecting a particular sector and the character performing the corresponding steps.

10. A method as claimed in claim 2 wherein, in order to provide instructions to the character about a desired body movement, the user drags a marker along a route across the virtual stage, and the character follows along that route.

11. A method as claimed in claim 10 wherein the character walks or runs depending on how fast the marker is moved by the user.

12. Computer software to enable a method as claimed in claim 2 to be performed.
